(19) United States
(12) Patent Application Publication
(10) Pub. No.: US 2015/0021863 A1
(43) Pub. Date: Jan. 22, 2015

(54) Mutiple-Leak Proof Sealiing System

(71) Applicant: Jui-Kung WANG, New Taipei City (TW)

(72) Inventor: Jui-Kung WANG, New Taipei City (TW)

(21) Appl. No.: 13/947,209

(22) Filed: Jul. 22, 2013

(51) Int. Cl. F16L 23/18

(52) U.S. Cl. CPC F16L 23/18
USPC 277/614

(57) ABSTRACT

A Multipe-leark proof sealing system which is used to join two components sealed together and comprises: a first adapter ring and a second adapter ring and comprising a first joint face and a second joint face, which are opposite to each other, respectively, wherein the first joint face and the second joint face have gasket grooves which are opposite to each other; sealing gaskets which are embedded into the first adapter ring's and the second adapter ring's gasket grooves; a metal sealing ring installed between sealing gaskets on the first adapter ring and the second adapter ring; an auxiliary sealing ring joining the sealing ring's radial inner wall. The sealing structure with multiple sealing surfaces is developed when the first adapter ring and the second adapter ring join together by fastenings.

### BACKGROUND OF THE INVENTION

1) Field of the Invention

The present invention relates to a sealing structure, particularly a sealing structure which develops multiple sealing faces and is used in joining two components to be connected to each other and sustaining high pressures.

2) Description of the Prior Art

A lot of conventional implements, devices or facilities for fluid (liquid and gas) applications need sufficient airtight capacity and sealing effect to ensure normal operations, for example, adequate sealing effect at joints of two pipelines used to transport high-pressure fluids or sufficient airtight capacity and pressure-resistant effect in special-purpose sealed containers such as industrial high-pressure gas chambers or reactors for no risk of leakage. Meanwhile, high pressure states hereinbefore imply both positive pressures and negative pressures.

In conventional implements, devices or facilities used in fluids, leakproof gaskets made of plastic elastic rubber are essential elements installed at joint faces of any two components. When two components interconnect with each other, a rubber leakproof gasket compressed at joint faces is deformed and facilitates development of faying surfaces at the two components' joint faces for leakproof and sealing effect. According to categories, purposes, and demands in pressures and leakage resistance of fluids in use, one or more leakproof gaskets based on faying surfaces can be used for better leakproof and sealing effect.

The conventional leakproof gaskets used in implements, devices or facilities for liquid fluids are effective in leakproof and sealing functions in virtue of propagated pressure fluctuations in liquid molecules. However, it is difficult to realize high-level leakproof and sealing functions by the conventional rubber leakproof gaskets which are used in implements, devices or facilities for gaseous fluids, particularly applications of high pressure gases, such as joint faces of high-pressure gas pipe lines or sealing faces on a container in which high pressure gases are held.

### SUMMARY OF THE INVENTION

The present invention presents a Multipe-leark proof sealing system used to joining two components to be connected to each other and sustaining high pressures for adequate sealing anti-vibration effect because conventional leakproof gaskets which are installed in implements, devices or facilities with high-pressure fluids held usually fail in leakage control and sealing effect.

In one embodiment of the present invention, the Multipe-leark proof sealing system comprises: a first adapter ring and a second adapter ring situated at a junction of two components to be connected to each other and comprising a first joint face and a second joint face, which are opposite to each other, respectively, wherein the first joint face and the second joint face have a first gasket groove with a V-shaped cross-section and a second gasket groove with a V-shaped cross-section, which are opposite to each other, respectively; a first sealing gasket and a second sealing gasket which are embedded into the first gasket groove and the second gasket groove, respectively; a metal sealing ring installed between the first sealing gasket and the second sealing gasket; an auxiliary sealing ring joining the sealing ring's radial inner wall. When the first adapter ring joins the second adapter ring by fastenings, the sealing ring creates a gap for development of a leak detection joint between the first joint face and the second joint face and closely fits the first gasket groove, the second gasket groove, the first sealing gasket, and the second sealing gasket to constitute a sealing structure with multiple sealing surfaces.

For a hexagonal cross-section of the sealing ring in the present invention in one embodiment, at least two bevels closely fit lateral walls in a V-shaped cross-section of the first gasket groove and at least other two bevels closely fit lateral walls in a V-shaped cross-section of the second gasket groove. The sealing ring also closely fits the first sealing gasket and the second sealing gasket at its two axial ends to constitute a sealing structure with multiple sealing surfaces.

The auxiliary sealing ring used in the present invention in one embodiment is one component made of a soft material such as Teflon and used to develop a planar sealing area for fluids and effectively moderate residual space in which bacteria are accumulated.

It can be seen from the disclosure that the present invention of a Multipe-leark proof sealing system creates multiple sealing surfaces by means of the sealing ring, the first gasket groove and the second gasket groove with V-shaped cross-sections, the first sealing gasket, and the second sealing gasket. Experimentally, the present invention is effective in airtight capacity without leakage in a helium leak test of 10⁻⁶ Torr. Furthermore, the sealing ring creates a gap for development of a leak detection joint which exists between the first joint face and the second joint face and facilitates leak detection from time to time.

The detailed effects of the present invention are described in embodiments and accompanying drawings hereinafter.

### BRIEF DESCRIPTIONS OF THE DRAWINGS

FIG. 1 is a sectional view illustrating the present invention used in joining two high-pressure pipe lines in one embodiment.

FIG. 2 is an exploded view illustrating components in the embodiment in FIG. 1.

FIG. 3 is an exploded view illustrating components of the present invention which is used in joining a metal canister and a sealing cap thereof in an alternative embodiment.

FIG. 4 illustrates assembled components in the embodiment in FIG. 3 and a partial sectional structure of the present invention with sealing completed.

### DETAILED DESCRIPTIONS OF THE PREFERRED EMBODIMENTS

The present invention of a Multipe-leark proof sealing system is described in the following sections and accompanying diagrams which disclose the present invention used in various implements, devices or facilities with fluids held and structure of the present invention in embodiments.

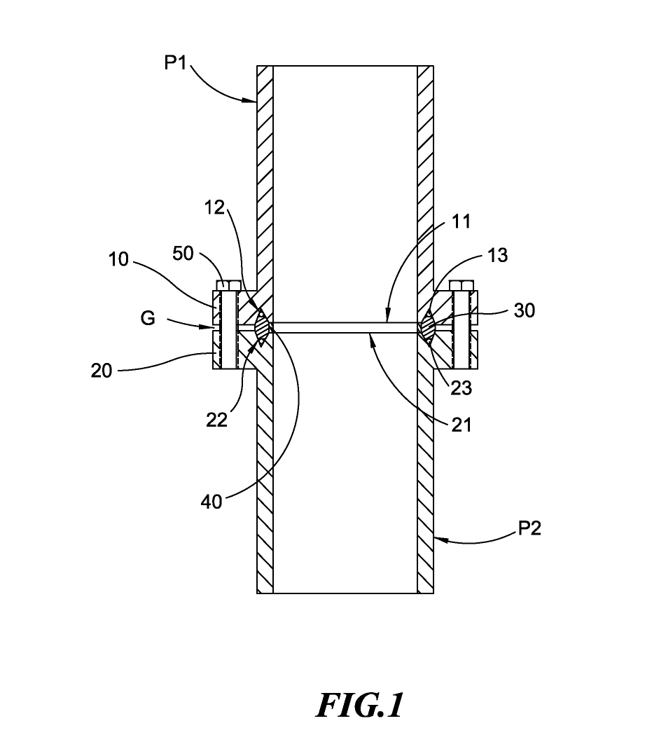

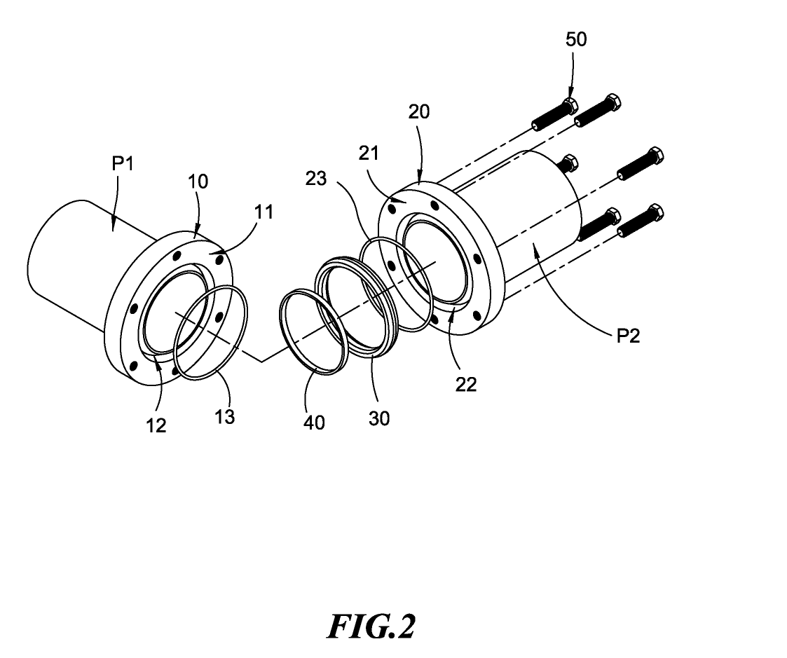

Refer to FIG. 1 and FIG. 2 that illustrate the present invention of a Multipe-leark proof sealing system used to join two high-pressure pipe lines P1, P2 and comprising a first adapter ring 10 and a second adapter ring 20, both of which are situated at a junction of the high-pressure pipe lines P1, P2 and are ringlike components axially contacting tail ends of the high-pressure pipe line P1 and the high-pressure pipe line P2, respectively: the first adapter ring 10 (second adapter ring 20) is coupled with the high-pressure pipe line P1 (high-pressure pipe line P2); in other words, the first adapter ring 10 (second adapter ring 20) and the high-pressure pipe line P1 (high-pressure pipe line P2) are made of an identical material including, without limitation, a metal material in general, by referring to the high-pressure pipe line P1 (high-pressure pipe line P2).

The first adapter ring 10 has a first joint face 11 and the second adapter ring 20 has a second joint face 21: the first joint face 11 is opposite to the second joint face 21; the first joint face 11 and the second joint face 21 comprise a first gasket groove 12 with a V-shaped cross-section and a second gasket groove 22 with a V-shaped cross-section, respectively; the first gasket groove 12 and the second gasket groove 22 are opposite to each other; two lateral walls in the V-shaped cross-section of the first gasket groove 12 present an included angle, as do two lateral walls in the V-shaped cross-section of the second gasket groove 22.

A first sealing gasket 13 and a second sealing gasket 23 are embedded into the first gasket groove 12 and the second gasket groove 22, respectively; a metal sealing ring 30 is held between the first sealing gasket 13 and the second sealing gasket 23 and provided with an auxiliary sealing ring 40 joining a radial inner wall of the sealing ring 30. The sealing ring 30 creates a gap for development of a leak detection joint G between the first joint face 11 and the second joint face 21, which are connected to each other by way of fastenings 50, and closely fits the first gasket groove 12, the second gasket groove 22, the first sealing gasket 13, and the second sealing gasket 23 to constitute sealing surfaces and further a sealing structure with the multiple sealing surfaces.

Experimentally, the Multipe-leark proof sealing system is effective in airtight capacity without leakage in a helium leak test of 10⁻⁶ Torr. Furthermore, the leak detection joint G between the first joint face 11 and the second joint face 12 facilitates leak detection based on a leak test device from time to time.

As shown in FIG. 1 for one embodiment of the present invention, the fastenings 50 are a number of bolts (or other equivalents) penetrating both the first adapter ring 10 and the second adapter ring 20 and equally distributing around circumferences thereof for stable connections of the first adapter ring 10, the second adapter ring 20, and the high-pressure pipe lines P1, P2. For a hexagonal cross-section of the sealing ring 30, at least two bevels closely fit lateral walls in the V-shaped cross-section of the first gasket groove 12 and at least other two bevels closely fit lateral walls in the V-shaped cross-section of the second gasket groove 22 when the first adapter ring 10 joins the second adapter ring 20 by way of the fastenings 50. The sealing ring 30 also closely fits the first sealing gasket 13 and the second sealing gasket 23 at its two axial ends to develop sealing surfaces and further a sealing structure with the multiple sealing surfaces.

The auxiliary sealing ring 40 used in the present invention in one embodiment is made of a soft sealing material (Teflon or rubber) and used to develop a planar sealing area in special-purpose fluid equipment for biological applications, effectively moderating residual space in which bacteria are accumulated.

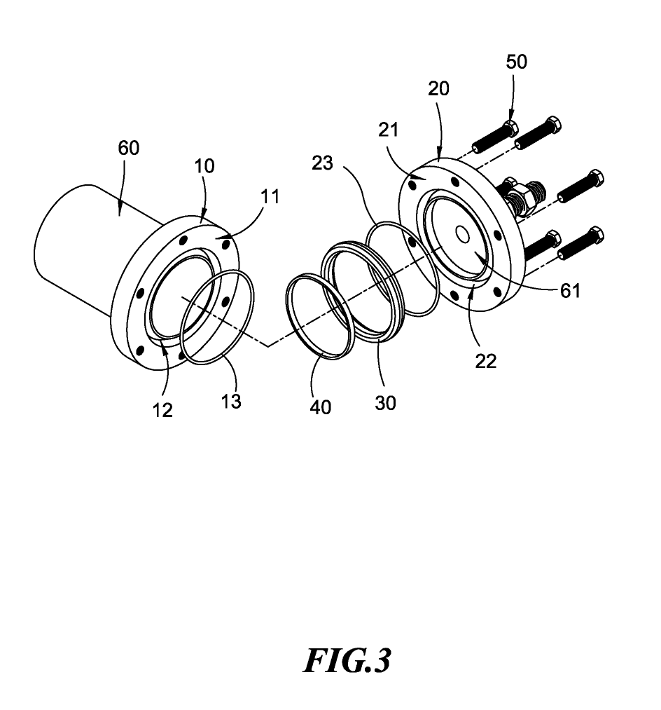

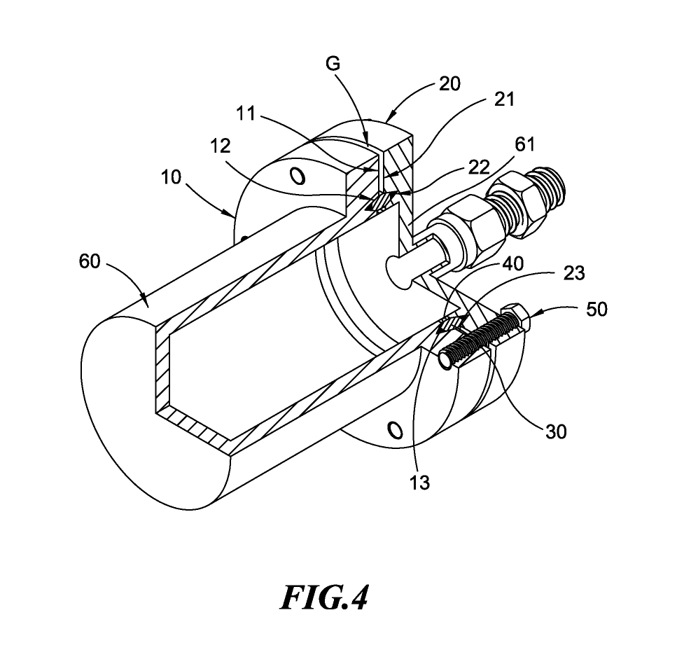

Refer to FIG. 3 and FIG. 4 which illustrate an alternative embodiment of the present invention of a Multipe-leark proof sealing system joining a metal canister 60 and a sealing cap 61 thereof.

The embodiments of the present invention disclosed hereinbefore should not be taken as examples to limit the present invention and may be changed or improved by any person skilled in the art without departing from spirit and range of the present invention. Therefore, the protective scope of the present invention should refer to claims herein.

What is claimed is:

1. A Multipe-leark proof sealing system used to join two components sealed together and comprising:
A first adapter ring and a second adapter ring which are installed at a junction of two components to be connected to each other: said first adapter ring has a first joint face and said second adapter ring has a second joint face; said first joint face is opposite to said second joint face; said first joint face and said second joint face comprises a first gasket groove with a V-shaped cross-section and a second gasket groove with a V-shaped cross-section, respectively; said first gasket groove is opposite to said second gasket groove;
A first sealing gasket which is embedded into said first gasket groove on said first joint face;
A second sealing gasket which is embedded into said second gasket groove on said second joint face;
A metal sealing ring which is coupled with and situated between said first sealing gasket and said second sealing gasket;
An auxiliary sealing ring which joins said sealing ring's radial inner wall;
Said first adapter ring is coupled with said second adapter ring by fastenings and said sealing ring creates a gap for development of a leak detection joint between said first joint face and said second joint face.

2. The Multipe-leark proof sealing system according to claim 1 wherein said sealing ring has a hexagonal cross-section in which at least two bevels closely fit lateral walls in said first gasket groove's V-shaped cross-section and at least other two bevels closely fit lateral walls in said second gasket groove's V-shaped cross-section and said sealing ring closely fits said first sealing gasket and said second sealing gasket at its two axial ends.

3. The Multipe-leark proof sealing system according to claim 1 wherein said auxiliary sealing ring is a soft component made of Teflon.

4. The Multipe-leark proof sealing system according to claim 1 wherein said fastenings are a number of bolts penetrating said first adapter ring and said second adapter ring.
